(19) United States
(12) Patent Application Publication
(10) Pub. No.: US 2013/0074733 A1
(43) Pub. Date: Mar. 28, 2013

(54) METHOD OF CLEANING A MATERIAL

(71) Applicants: Lalit Chordia, Pittsburgh, PA (US); Jose L. Martinez, Gibsonia, PA (US); Bhishmakumar Desai, Pittsburgh, PA (US)

(72) Inventors: Lalit Chordia, Pittsburgh, PA (US); Jose L. Martinez, Gibsonia, PA (US); Bhishmakumar Desai, Pittsburgh, PA (US)

(21) Appl. No.: 13/702,868

(22) PCT Filed: Jun. 9, 2011
(86) PCT No.: PCT/US11/01046

§ 371 Date: Dec. 7, 2012

Related U.S. Application Data
(60) Provisional application No. 61/397,280, filed on Jun. 9, 2010.

(51) Int. Cl. B08B 3/14

(52) U.S. Cl. CPC B08B 3/14
USPC 106/287.35; 134/10; 420/580

(57) ABSTRACT

Solid waste of metallic or plastic composition is cleansed of contaminants by solvent extraction using a combination of primary solvent and co-solvents that may be pressurized and heated to above the critical state. The process is particularly applicable to the remediation of solids contaminated with polychlorinated biphenyls. Contamination can be reduced to less than two parts per million (by weight).

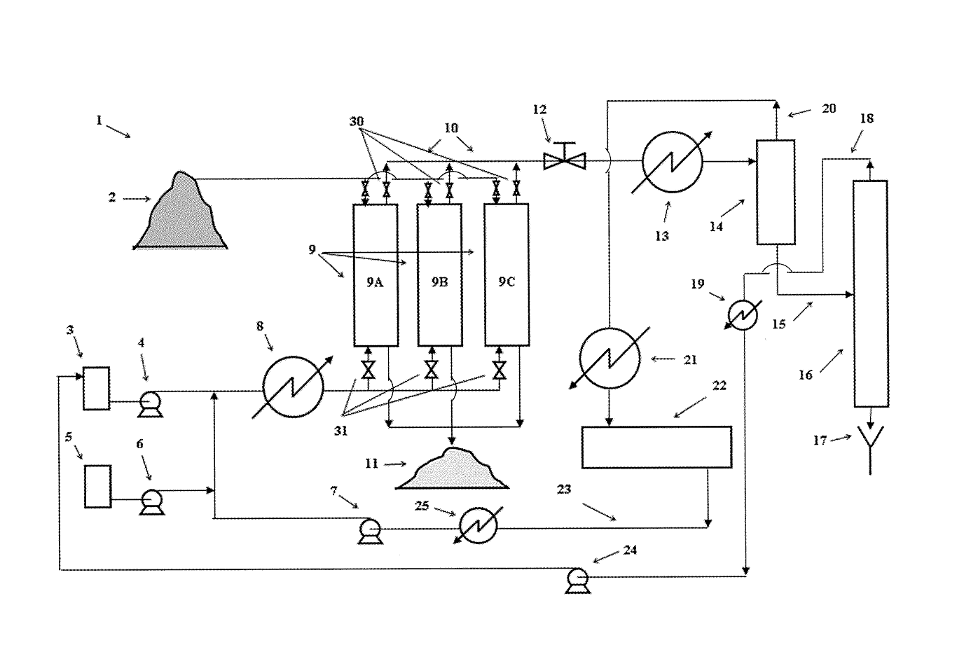

### CROSS-REFERENCE TO RELATED APPLICATIONS

This application is US national phase application of PCT international application No. PCT/US2011/001046, titled: METHOD OF CLEANING A MATERIAL, filed on Jun. 9, 2011, which is a Non-provisional Application of U.S. Provisional Application No. 61/397,280, titled: METHOD OF CLEANING A MATERIAL, filed on Jun. 9, 2010, herein incorporated by reference.

### FIELD OF THE INVENTION

This invention pertains to the remediation of solid objects that have been contaminated with hazardous substances, and most particularly solid objects contaminated with polychlorinated biphenyl.

### BACKGROUND OF THE INVENTION

The health and environmental dangers posed by polychlorinated biphenyls (PCBs) have been known since before World War II. Aggressive efforts to regulate their use and to clean up water, soils and manufactured goods that are contaminated with PCBs began in earnest by the early 1970s. Rules established by the U.S. Environmental Protection Agency by the time of this disclosure set standards for remediated bulk waste of less than 25 ppm for low-occupancy areas and less than 1 ppm for high occupancy areas. For non-aqueous liquids, the standard is less than 2 ppm. This latter standard, 2 ppm, is taken as the industry standard for acceptable remediation of solid wastes such as those resulting from the disposal of metals or plastics from such sources as junked automobiles and other manufactured goods.

Methods far remediating PCB-contaminated wastes have been the subject of numerous patent disclosures in the past. Many involve degreasing processes, wherein a solvent, typically a chlorinated solvent, dissolves PCBs from the surfaces of waste solids. Transformers, which once were manufactured containing PCBs as a dielectric oil, are commonly cleaned by this method. The process generates a new waste, in the form of a PCB-containing solution, which is generally incinerated to destroy the PCBs.

Various solvents, if applied in a pressurized or supercritical state, can be used to dissolve contaminants from solid wastes. Then, by means of a change of state either by altering temperature or pressure, the contaminants drop out of solution and the solvent can be re-used. This method has been applied in numerous applications involving such articles as soil, waste carpets, used plastic containers, “stickies” from waste paper, the purification of plastic resins, fabrics, and even the buttons sewn on fabrics. With the exception of soil remediation, none of these methods, so far as is known, applies either to PCB contaminants specifically, or to contaminant remediation to the low levels demanded by environmental regulations for PCBs.

There exist numerous articles of solid waste that may contain PCB and which require decontamination to less than 2 ppm. Shredded junk automobiles are a prime example. PCBs may stem from various fluids from engine and transmission parts, from plastics and from paints. Decontamination of such metallic and plastic wastes to less than 2 ppm has heretofore been unattainable with reusable solvent.

### SUMMARY OF THE INVENTION

The present invention describes a method for cleaning a solid waste, including removing PCBs if it is present in that material. In one preferred embodiment, the solid waste is shredder residue from automobile reclamation. This type of waste material may be composed of such materials as plastics, rubber, fibers, foams, non-ferrous metals, ferrous metals, wood, fines and rock-like materials, or any combination thereof.

The disclosed method of removing polychlorinated biphenyl contaminants from solid waste is comprised of steps that include: (1) the placement of contaminated solid waste in one of a series of enclosed vessels, hereinafter referred to as the extraction vessels; (2) the operation of a set of one or more extraction vessels at different stages of a cycle that consists of a sequence of solid-waste loading, pressurization, extraction, depressurization and unloading; (3) closing of an extraction vessel and the subsequent pumping of solvent into it, thereby pressurizing the vessel; (4) upon reaching a condition of temperature and pressure in an extraction vessel that is sufficient to dissolve the contaminants in the solvent, a stream of fresh solvent is pumped into the vessel while an extract stream of solvent and contaminants flows out of an extraction vessel; (5) contaminants and co-solvent are separated from the solvent and collected, and the separated solvent is pumped back to an extraction vessel; (6) after exposure to the stream of fresh solvent for a period of time long enough to effect the dissolution of sufficient quantities of contaminants from the solid waste, an extraction vessel is depressurized and opened, whereupon the solid raffinate is collected. The solvent employed in this process consists of a primary solvent taken from a group that consists of ethane, propane, carbon dioxide, ethanol, nitrous oxide, butane, isobutene, sulfur hexafluoride, trifluoromethane, dimethylether, or a combination thereof but preferably carbon dioxide alone, together with one or more co-solvents taken from a group that includes but is not limited to methanol, ethanol, dimethylsulfoxide, tetrahydrofuran, N,N-dimethylformamide, toluene, dichloromethane, ethyl ether, heptane, hexane, methylethylketone, methylisobutylketone, acetone, chloroform, fluoroform, carbon tetrachloride, cyclohexane, ethyl acetate, ethyl formate, isobutyl acetate, isopropyl acetate, 2-methyl-1-propanol, pentane, 1-pentanol, 1-propanol and 2-propanol, or a combination thereof. The concentration of the co-solvent may be varied from 0%-wt to 50%-wt, or preferably 1%-wt to 50% -wt, or most preferably 8%-wt to 20%-wt at any time during the process. The solvent is pressurized to a range between 80 and 1,000 bar, preferably in the range of 200 to 800 bar, and most preferably in the range of 325 to 600 bar. The solvent is heated to a range between 20 and 150 degrees Celsius, and preferably between 60 and 125 degrees Celsius. However, in another embodiment of the present invention, the temperature can be between about 225 and 350 degrees Celsius.

In accordance with the best practice of this disclosure, a remediated material, obtained as solid matter that is depleted of contaminates and referred to as the raffinate of extraction, contains less than 2 parts per million of polychlorinated biphenyl. Such material is composed primarily (greater than 50%) metals and/or plastics or any combination thereof.

### BRIEF DESCRIPTION OF THE DRAWINGS

The FIGURE is a pictorial representation of the process for the extraction of contaminants from solid waste by means of solvent extraction for one exemplary embodiment of the present invention.

### DETAILED DESCRIPTION OF THE INVENTION

Referring to the FIGURE, one embodiment of the remediation process 1 starts with solid waste 2 that has been shredded, pulverized or by other means reduced to small particles. This waste typically comes from industrial sources, including shredded junked automobiles. Any such waste may be composed of such materials as plastics, rubber, fibers, foams, non-ferrous metals, ferrous metals, wood, fines and rock-like substances, or any combination thereof.

A set of extraction vessels 9A-C stand ready to accept a feed of solid material via a belt, pneumatic or other type of conveyance system. Material is fed to one vessel at a time. While a vessel 9, such as 9A, is open and being fed with solid material, the other vessels, such as 9B and 9C, are closed and are at varying stages of extraction. For example, the second vessel 9B in a three-vessel set could be in the first half of its extraction cycle while the third vessel 9C in a three-vessel set is in the second half of its extraction cycle. Once feeding of the first vessel 9A is complete and that vessel 9A is closed, the extraction cycle of the second vessel 9B comes to end and solvent flow to that vessel 9B ceases. The vessel 9B is then unloaded of its decontaminated raffinate. Meanwhile, the third vessel 9C enters the second half of its extraction cycle and the first, freshly closed vessel 9A begins its cycle. There is no restriction on the number of extraction vessels 9 in this process. If more than three vessels 9 are operating in series, each vessel 9 may operate in phases that are fractionally less than the three-vessel 9 example cited herein. Alternatively, a second set of vessels (not shown) may operate in parallel with the first set of vessels 9 in accordance with the same or different phase schedule.

The solvent may be pressurized in vessels 9, and the pressure of the solvent can exceed its critical pressure. The temperature of the solvent may also exceed its critical temperature before entering vessels 9. Solvent can be fed through the mass of waste material in vessels 9 in parallel, cross-flow or counter-current manner (as shown in the FIGURE). Within a single set of vessels 9 there is no restriction on the temperature-pressure extraction profile of a particular vessel 9. For example, one of the vessels 9 undergoing extraction may be held at a different condition of pressure or temperature, or both, than the other vessels 9, as might be the case if the last vessel 9C in the series begins depressurization in anticipation of its re-opening to dispense de-contaminated solids. This method also applies to a single vessel 9 operating in a strictly batch mode, undergoing a series of cyclical changes of loading, re-pressurization, extraction, de-pressurization and unloading.

The primary solvent employed in this process is taken from a group that consists of ethane, propane, carbon dioxide, ethanol, nitrous oxide, butane, isobutene, sulfur hexafluoride, trifluoromethane, and dimethylether, with carbon dioxide being the preferred primary solvent. This solvent may be mixed with one or more co-solvents taken from a group that includes but is not limited to methanol, ethanol, dimethylsulfoxide, tetrahydrofuran, N,N-dimethylformamide, toluene, dichloromethane, ethyl ether, heptane, hexane, methylethylketone, methylisobutylketone, acetone, chloroform, fluoroform, carbon tetrachloride, cyclohexane, ethyl acetate, ethyl formate, isobutyl acetate, isopropyl acetate, 2-methyl-1-propanol, pentane, 1-pentanol, 1-propanol and 2-propanol, or a combination thereof. The concentration of co-solvent in the primary solvent may vary from 0%-wt to 50%-wt, or preferably 1%-wt to 50%-wt, or most preferably 8%-wt to 20%-wt during all or part of the cycle. Pressure and temperature are maintained, together with the amount of fresh solvent fed into an extractor during a cycle, so as to achieve an economically optimum rate of contaminant extraction. The extraction time will depend on the process parameters selected. The process is complete once that the targeted residual PCB content is achieved. For the process as disclosed herein, the required pressure ranges from 80 to 1,000 bar generally, and in the preferred embodiment it ranges from 200 to 800 bar; and in the most preferred embodiment it ranges from 350 to 600 bar; the required temperature ranges from 20 to 150 degrees Celsius generally, and in the preferred embodiment it ranges from 60 to 125 degrees Celsius, and in the one embodiment it ranges from 225 to 350 degrees Celsius.

Both primary solvent and co-solvent are recycled in the process, but any lost solvent or co-solvent is replenished from make-up tanks 3 and pumps 4 for co-solvent and source tank 5 and pump 6 for primary solvent. The recycled solvent is fed into the recycle stream of primary solvent 23, which is impelled by recycle pump 7. A pump pre-cooler 25 ahead of recycle pump 7 ensures liquid solvent flow to the suction of the pump 7. Alternatively, this pump/pre-cooler combination could be replaced by a compressor (not shown) that moves the recycled solvent. Meanwhile, recycled co-solvent 18, if co-solvent is employed, undergoes a similar return to the extractor vessels 9 via a co-solvent pre-cooler 19 and pump 24. Before the combined solvent/co-solvent recycle stream returns to the extraction vessel set 9, it passes through a preheater 8 to bring it to the temperature specified for extraction ranging from 20 to 150 degrees Celsius generally, and in the preferred embodiment it ranges from 60 to 125 degrees Celsius, and in another embodiment it ranges from 225 to 350 degrees Celsius.

The pressure of the supercritical fluid 10 in the extractor vessels 9A, 9B and 9C is maintained by pressure regulator 12. Vessels oulet valves 30 of two of the vessels 9 are closed to measure the pressure of the third vessel 9 with its oulet valve 30 remaining open. Therefore two vessels 9 are isolated while the third vessel is open to pressure regulator 12. Following depressurization through pressure regulator 12, fluid is re-heated in heater 13 so as to ensure the proper combination of temperature and pressure for separator 14. Pressure can range from 40-60 bar, and temperature can range from 6-23° C., from which recycled solvent 20 exits as a gas, and co-solvent together with contaminants 15 exits as a liquid. This disclosure is not to limit the invention to simple gas-liquid separation. Inlet valves 31 can also by provide to closed the fluid inlet. An alternative method is liquid-liquid phase separation (not shown) that is achieved more by temperature control of extract stream 10 than by pressure control. Other methods include adsorption of contaminants onto media that is later heated or purged to displace and recover the adsorbed components; also, the selective or fractional passage of either the solvent or solute through a membrane.

From the separator 14, recycled solvent 20 is condensed in cooler 21 and fed into receiver 22, which serves to accommodate variations in solvent demand during the intermittent openings and closures of the extractor vessels 9. The co-solvent/contaminant stream 15, meanwhile, is sent to distillation column 16 for thermal separation. The isolated contaminant 17 is collected from this unit.

Clean solids 11 are collected from the extraction vessel 9 via a belt, pneumatic or other type of conveyance system. Removal may occur via a separate opening at the bottom of an extraction vessel 9 (as shown in the FIGURE), or from the top (not shown). Once emptied, the extraction vessel 9 is re-filled with a new batch of contaminated solids, closed, and then re-pressurized with solvent or a combination of solvent and co-solvent. It is understood that the flow out of the extraction vessel 9 does not begin until the extraction vessel 9 pressure has reached the level set by pressure regulator 12, whereupon the outlet stream, i.e. the supercritical fluid and compounds extracted 10 is mixed with the outlet streams from other vessels 9 before passing through the pressure regulator 12. As discussed above, downstream pressure regulation 12 independently controls the outlet of upstream vessels 9 when only one vessel 9 has valve 30 opened. The flow of solvent to the extraction set of vessels 9 is continuous if more than one vessel is operating. As discussed above, the set pressure ranges from 80 to 1,000 bar generally, and in the preferred embodiment it ranges from 200 to 800 bar; and in the most preferred embodiment it ranges from 325 to 600 bar.

Depending on the choice of solvent and co-solvent, and of key operating conditions, particularly pressure, temperature and the solvent-to-solids mass ratio, it is possible to reduce the contaminant concentration in the raffinate to less than 2 parts per million (by weight). The choice of operating conditions is itself dependent mainly on the concentration and chemical nature of the contaminants in the raw waste. In one embodiment of this disclosure, solid waste composed of metal and plastics and contaminated with polychlorinated biphenyls can be cleaned to less than 2 parts per million of PCBs. Solubility of PCBs depends on pressure, temperature, as well as chemical structure, molecular weights, intermolecular forces, polarity, etc. Therefore the process parameters will vary based on supercritical solvent and co-solvents used. Additionally the extraction depends on the feedstock or raw material. The first step of the process is to determine the chemistry of the raw starting material, such as automobile shredder residue. The next step is to select the solvents and optionally select co-solvents along with the appropriate extraction pressures and temperature to yield the desired contamination reduction, such as less than 2 ppm of PCBs.

### EXAMPLES

The following examples all involve the removal of PCBs from automobile shredder residue.

### Example 1

| | |
|---|---|
| Raw material: | Plastics with a PCB |
| | content of 39.8 ppm |
| Process conditions: | |
| Extraction Vessel Pressure | 600 bar |
| Extraction Vessel Temperature | 100 C. |
| CO₂ flow rate | 100 g/min |
| Residual PCB content: | 0.76 ppm |

### Example 2

| | |
|---|---|
| Raw material: | Plastics with a PCB |
| | content of 12.1 ppm |
| Process conditions: | |
| Extraction Vessel Pressure | 200 bar |
| Extraction Vessel Temperature | 80 C. |
| CO₂ flow rate | 100 g/min |
| Residual PCB content: | 1.95 ppm |

### Example 3

| | |
|---|---|
| Raw material: | Plastics with a PCB |
| | content of 18.3 ppm |
| Process conditions: | |
| Extraction Vessel Pressure | 200 bar |
| Extraction Vessel Temperature | 100 C. |
| CO₂ flow rate | 87 g/min |
| Co-solvent | Methanol |
| Co-solvent flow rate | 13 g/min |
| Residual PCB content: | 0.69 ppm |

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method for removing polychlorinated biphenyl contaminants from contaminated plastics or metals, comprising the steps of:
placing the plastics or metals in an extraction vessel;
heating a solvent to above its critical temperature;
pressurizing the vessel with the heated solvent to a predetermined pressure;
pumping a stream of fresh solvent into the extraction vessel while an extract stream of solvent with dissolved contaminants therein flows out of the extraction vessel;
separating the dissolved contaminants in the solvent and collecting the separated contaminants;
pumping the separated solvent back to the extraction vessel;
depressurizing the extraction vessel;
unloading solid raffinate from the extraction vessel; and
wherein the solid raffinate contains less than 2 parts per million of polychlorinated biphenyl.

2. The method according to claim 1, further comprising two or more extraction vessels.

3. The method according to claim 2, further comprising the step of operating the two or more extraction vessel at different stages of a cycle, wherein the stages comprise a sequence of solid-waste loading, pressurization, extraction, depressurization and unloading.

4. The method according to claim 1, wherein the solvent is only carbon dioxide.

5. The method according to claim 1, wherein the heated solvent is selected from a group consisting of ethane, propane, carbon dioxide, ethanol, nitrous oxide, butane, isobutene, sulfur hexafluoride, trifluoromethane, dimethylether, and a combination thereof

6. The method according to claim 1, further comprising with one or more co-solvents selected from a group consisting of methanol, ethanol, dimethylsulfoxide, tetrahydrofuran, N,N-dimethylformamide, toluene, dichloromethane, ethyl ether, heptane, hexane, methylethylketone, methylisobutylketone, acetone, chloroform, fluoroform, carbon tetrachloride, cyclohexane, ethyl acetate, ethyl formate, isobutyl acetate, isopropyl acetate, 2-methyl-1-propanol, pentane, 1-pentanol, 1-propanol and 2-propanol, and a combination thereof.

7. The method according to claim 6, further comprising the steps of:
separating the contaminants and co-solvent from the solvent; and
collecting the separated contaminants.

8. The method according to claim 7, further comprising the step of pumping the separated co-solvent back to the extraction vessel.

9. The method according to claim 1, wherein the concentration of the co-solvent can be varied from 0%-wt to 50%-wt at any time during the process.

10. The method according to claim 1, wherein the concentration of the co-solvent can be varied from 1%-wt to 50%-wt.

11. The method according to claim 1, wherein the concentration of the co-solvent can be varied from 8%-wt to 20%-wt.

12. The method as described in claim 1, wherein the predetermined pressurize ranges between 80 and 1,000 bar.

13. The method as described in claim 1, wherein the predetermined pressurize ranges between 200 to 800 bar.

14. The method as described in claim 1, wherein the predetermined pressurize ranges between 325-600 bar.

15. The method as described in claim 1, wherein the critical temperature ranges between 20 and 150 degrees Celsius

16. The method as described in claim 1, wherein the critical temperature ranges between 60 and 125 degrees Celsius.

17. The method as described in claim 1, wherein the critical temperature ranges between 225 and 350 degrees Celsius.

18. A remediated material according to the method of claim 1, wherein the remediated material contains greater than 50% metals or plastics or any combination thereof.

19. A remediated material according to the method of claim 1, wherein the remediated material contains greater than 50% metals.

20. A remediated material according to the method of claim 1, wherein the remediated material contains greater than 50% plastic.

21. A remediated material according to the method of claim 1, wherein the remediated material contains greater than 50% of a combination of metals and plastic.

22. The method as described in claim 1, wherein the separated solvent is a liquid.

23. The method as described in claim 1, wherein the separated solvent is a gas.

24. The method as described in claim 1, wherein the step of separating the dissolved contaminants in the solvent is done by depressurization.

25. The method as described in claim 1, wherein the step of separating the dissolved contaminants in the solvent is done by changes in temperature.

26. The method as described in claim 1, wherein the step of separating the dissolved contaminants in the solvent is done by adsorption.

27. The method as described in claim 1, wherein the step of separating the dissolved contaminants in the solvent is done by a membrane.

28. The method as described in claim 1, wherein the contaminated plastics or metals are automobile shredded residue.
